(19) United States
(12) Patent Application Publication
(10) Pub. No.: US 2009/0300252 A1
(43) Pub. Date: Dec. 3, 2009

(54) MONITOR WITH PERIPHERAL EQUIPMENT INTERFACE AND COMPUTER

(75) Inventors: YI-HONG LIU, Shenzhen City (CN); YUN-SHAN XIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD, Shenzhen City (CN); HON HAI PRECISION INDUSTRY CO., LTD., Tu-Cheng (TW)

(21) Appl. No.: 12/192,090

(22) Filed: Aug. 14, 2008

(30) Foreign Application Priority Data
May 30, 2008 (CN) 200810301870.7

(51) Int. Cl. G06F 13/00

(52) U.S. Cl. 710/302

(57) ABSTRACT

A monitor for a host computer includes a display circuit, a peripheral equipment interface, a power circuit, and a monitor video interface. The display circuit is capable of controlling display of the monitor. The peripheral equipment interface is disposed on a frame of the monitor. The peripheral equipment interface includes a plurality of signal pins. The power circuit is capable of providing power to the display circuit and the peripheral equipment interface. The monitor video interface mates with a video interface of a motherboard of the host computer. The monitor video interface includes a plurality of video pins and idle pins. The video pins are connected to the display circuit. The idle pins are connected to the idle pins of the motherboard video interface. The idle pins of the motherboard video interface are connected to a chip of the motherboard.

### BACKGROUND

1. Field of the Invention

The present invention relates to a monitor with a peripheral equipment interface (PEI) and a computer.

2. Description of Related Art

Nowadays, computers with monitors are widely used. The monitors typically serve only one function, to be the display means for the computers they are connected to. However, given the usual proximity of a monitor in a computer system to a user, a monitor with a peripheral equipment interface would greatly expand the enhance the functionality of, and using experience with, the computer system.

What is needed, therefore, is a monitor with a peripheral equipment interface to expand functionality of the monitor.

### BRIEF DESCRIPTION OF THE DRAWINGS

FIG. 1 is a schematic view of a monitor with a peripheral equipment interface in accordance with an embodiment of the present invention.

FIG. 2 is a circuit schematic diagram of the monitor with peripheral equipment interface and a motherboard of a computer associated with the monitor according to a first embodiment.

FIG. 3 is a circuit schematic diagram of the monitor with a peripheral equipment interface and a motherboard of a second embodiment.

### DETAILED DESCRIPTION

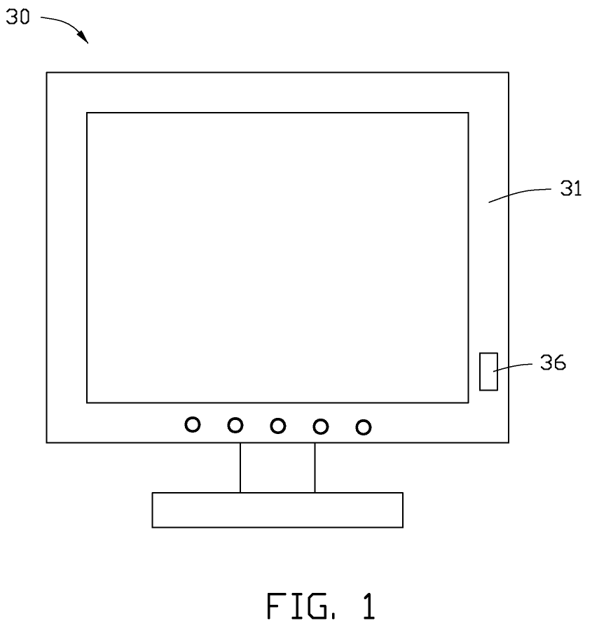

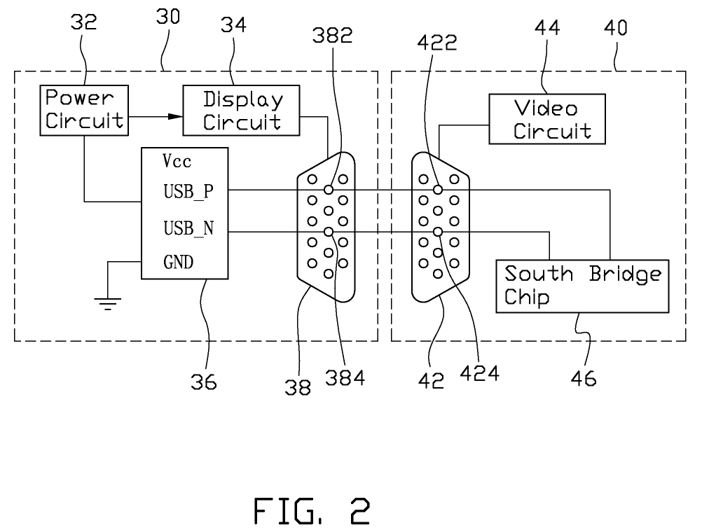

Referring to FIGS. 1 and 2, a monitor 30 with a peripheral equipment interface (PEI) in accordance with a first embodiment includes a power circuit 32, a display circuit 34, the PEI is a universal serial bus (USB) interface 36, and a monitor video interface such as a video graphics array (VGA) interface 38.

The USB interface 36 is mounted on a frame 31 of the monitor 30. The power circuit 32 and the display circuit 34 are set on a circuit board (not shown) of the monitor 30. The power circuit 32 is connected to the display circuit 34 to provide power for the display circuit 34. The power circuit 32 is connected to a power pin Vcc of the USB interface 36 to provide power for the USB interface 36. Two idle pins 382, 384 of the monitor VGA interface 38 are connected two signal pins USB-P, USB-N of the USB interface 36 respectively. A ground pin GND of the USB interface 36 is grounded. Video pins of the monitor VGA interface 38 are connected to the display circuit 34.

A motherboard 40 of a computer (not shown) includes a motherboard video interface such as a VGA interface 42, a video circuit 44, and a south bridge chip 46. The idle two pins 422, 424 of the motherboard VGA interface 42 are connected to two USB signal pins of the south bridge chip 46. The two pins 422, 424 of the motherboard VGA interface 42 are corresponding to the two pins 382, 384 of the monitor VGA interface 38 respectively. When the monitor VGA interface 38 is plugged into the motherboard VGA interface 42, the two pins 422, 424 of the motherboard VGA interface 42 are connected to the two pins 382, 384 of the monitor VGA interface 38 correspondingly. The video pins of the motherboard VGA interface 42 are connected to the video pins of the monitor VGA interface 38, therefore the monitor VGA interface 38 is connected to the video circuit 44.

In use, the monitor VGA interface 38 is plugged into the motherboard VGA interface 42. The power circuit 32 converts AC power into 12V DC power and 5V DC power. The 12V DC power is provided to the display circuit 34, and the 5V DC power is provided to the USB interface 36. The USB interface 36 is capable of communicating with the motherboard via the monitor VGA interface 38 and the motherboard VGA interface 42. Therefore the monitor 30 not only has display function but also provides a USB interface for connecting peripheral equipment to the computer.

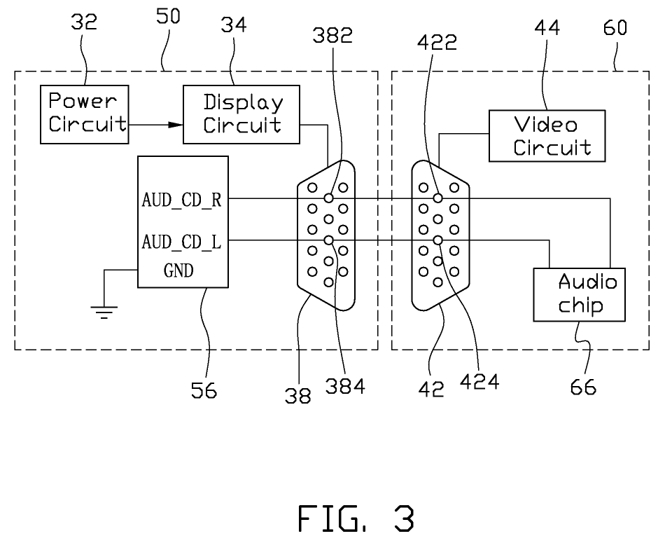

FIG. 3 illustrates a monitor 50 and a motherboard 60 in accordance with a second embodiment of the present invention. Power circuit 32, display circuit 34, monitor VGA interface 38 of the monitor 50 and motherboard VGA interface 42, video circuit 44 are the same as those of the first embodiment. The differences between the two embodiments are that in the second embodiment, the PEI is an audio interface 56, and the idle pins 422, 424 of the motherboard VGA interface 42 are connected to two audio signal pins of an audio chip 66. Therefore the monitor 50 not only has display function but also provides an audio interface for connecting audio equipment to the computer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A monitor for a host computer, comprising:
a display circuit capable of controlling display of the monitor;
a peripheral equipment interface (PEI) disposed on a frame of the monitor, comprising a plurality of signal pins;
a power circuit capable of providing power to the display circuit and the peripheral equipment interface; and
a monitor video interface mating with a video interface of a motherboard of the host computer, the monitor video interface comprising a plurality of video pins connected to the display circuit, and a plurality of idle pins connected to idle pins of the motherboard video interface which are connected to a chip of the motherboard;
wherein the signal pins of the peripheral equipment interface are connected to the idle pins of the monitor video interface.

2. The monitor as claimed in claim 1, wherein the peripheral equipment interface is a universal serial bus (USB) interface, the chip of the motherboard is a south bridge chip.

3. The monitor as claimed in claim 1, wherein the monitor video interface is a monitor video graphics array (VGA) interface, and the motherboard video interface is a motherboard monitor VGA interface

4. The monitor as claimed in claim 1, wherein the peripheral equipment interface is an audio interface, the chip of the motherboard is an audio chip.

5. A monitor system comprising:
a monitor comprising:
a display circuit capable of controlling display of the monitor;
a peripheral equipment interface disposed on a frame of the monitor, comprising a plurality of signal pins;
a power circuit capable of providing power to the display circuit and the peripheral equipment interface; and
a monitor video interface comprising a plurality of video pins connected to the display circuit, and a plurality of idle pins connected to the signal pins of the peripheral equipment interface; and
a host computer comprising a motherboard, wherein the motherboard comprising:
a video circuit for providing video signals to the monitor;
a motherboard video interface mating with the monitor video interface, the motherboard video interface comprising a plurality of video pins connected to the video circuit and the video pins of the monitor video interface, and a plurality of idle pins connected to the idle pins of the monitor video interface; and
a motherboard chip connected the idle pins of the motherboard video interface.

6. The monitor system as claimed in claim 5, wherein the peripheral equipment interface is a universal serial bus (USB) interface, the chip of the motherboard is a south bridge chip.

7. The monitor system as claimed in claim 5, wherein the monitor video interface is a video graphics array (VGA) interface, and the motherboard video interface is a motherboard VGA interface.

8. The monitor system as claimed in claim 5, wherein the peripheral equipment interface is an audio interface, the chip of the motherboard is an audio chip.
